(19) United States
(12) Patent Application Publication
(10) Pub. No.: US 2024/0268336 A1
(43) Pub. Date: Aug. 15, 2024

(54) MODULAR DUAL-BAG SYSTEM WITH MAGNETIC CLOSURE AND SWIVELING SHOULDER STRAPS

(71) Applicant: Pei H. Li, Whittier, CA (US)

(72) Inventor: Pei H. Li, Whittier, CA (US)

(21) Appl. No.: 18/494,226

(22) Filed: Oct. 25, 2023

Related U.S. Application Data
(63) Continuation-in-part of application No. 18/053,346, filed on Nov. 7, 2022.

(51) Int. Cl. A01K 1/02; A45F 3/04

(52) U.S. Cl. CPC A01K 1/029; A45F 3/047; A45F 2003/045

(57) ABSTRACT

A dual modular system designed for versatile dog transportation allows for the simultaneous carriage of two bags, e.g., one positioned at the wearer's chest and another functioning as a rear- or back-positioned dog carrier. The system may also be used as a single bag either at the front or the back. An inconspicuous magnetic closure may be hidden behind the water bottle pocket on the bags' lower rear, as well as a detachable magnetic closure on the shoulder strap. This setup permits side attachment of bags and facilitates the upper part of the dog carrier bag connecting with the rear bag's shoulder strap. The lower sections of the shoulder straps may be equipped with detachable side release (SR) buckles, allowing individual wearing of the bag at the front or back and enable the wearer to pivot the bag to the front or back through water bottle slits.

### CROSS-REFERENCE TO RELATED APPLICATIONS

This application claims priority to U.S. patent application Ser. No. 18/053,346, filed Nov. 7, 2022, and entitled “Personal Pet Carrier”, the entirety of which is incorporated by reference.

### TECHNICAL FIELD

The disclosed embodiments relate to a modular dual-bag system with a magnetic closure and swiveling shoulder strap allow the wearer to carry two bags simultaneously in a backpack and/or front pack configuration.

### BACKGROUND

Pet owners may enjoy engaging in activities with their pets, such as travel, hiking, or other activities that require extended periods of walking which their pets may not be capable of due to the pet's size, age, or various health issues. Such pet owners may seek a solution that allows them to participate in activities they find enjoyable and include their pet companion with which they may not otherwise be capable of enjoying with them.

One possible solution is the use of a pet carrying harness system, or pet carrier. Various types of pet carriers are available, some of which enable the pet owner to secure the pet to their person in a backpack or front pack configuration.

Typically, these types of pet carriers require the user to insert the pet's hind legs through holes in the lower portion of the pet carrier or place the pet's lower body in an open bag-like structure, which may then be zipped up to secure the pet. However, in either case, the pet may buck and kick during the procedure, which may be frustrating for both the pet owner and the pet, and increase the time and difficulty of securing the pet in the carrier.

Prior solutions often involve singular bag configurations, limiting the options for carrying multiple bags, particularly in the context of dogs. Traditional methods often necessitate separate bags and complicated attachment systems. The disclosed system addresses these limitations by offering a design in which the wearer can carry bags in various configurations to suit different scenarios.

### SUMMARY

Disclosed are various embodiments of a personal pet carrier. The personal pet carrier may include a bag portion to house the lower body of a pet. The sides of the bag may include open slits extending partially down the sides of the bag to facilitate scooping the pet's hind quarters and lower body into the bag. Side adjustment straps are provided near the top of the slits. The side adjustment straps may be attached to one side of the slit and include buckles on the other end to enable adjustment of the straps and to connect with a receiving piece on the other side of the slit.

A pair of shoulder straps may include a bottom portion attached to the bottom of the bag and a top portion with a hook piece. The bag may include loops on both the front and back sides of the bag to accept the hook piece in either a backpack configuration or a front pack configuration, respectively.

A molle harness system may be attached to the back of the bag on each side adjacent to a corresponding slit. A molle adjustment piece may be inserted into a molle appropriate for the size of the pet, and may include the side strap buckle receiving piece.

A collar strap may be connected adjacent to the top side of the back side of the bag portion. The collar strap may be attached near the top side of the bag portion at one end, and include a releasable connector at the other end. The connector may be a buckle system or hook-and-loop connector.

A choke prevention strap may be connected between the collar strap and the front side of the bag portion to prevent the pet from lifting its neck or climbing on the user's shoulders and possibly choking.

In an embodiment, a dual, modular pet carrier system may enable versatile dog transportation, including the simultaneous carriage of two bags. The system allows for the wearer to carry a bag at the front or back individually, or both bags simultaneously-one at the front and another at the back. The system may include inconspicuous magnetic closure mechanisms concealed behind the water bottle pocket on the bags' lower rear. A detachable magnetic closure may be located on the shoulder strap, enhancing the system's adaptability. Detachable side-release (SR) buckles may be incorporated into the lower sections of the shoulder straps allow wearers to pivot the bag to the front or back through water bottle slits, seamlessly adapting to different scenarios.

The disclosed dual modular system provides a valuable solution that caters to the needs of dog owners and individuals requiring adaptable bag arrangements.

### BRIEF DESCRIPTION OF THE DRAWINGS

FIG. 1 is a rear view of one bag in a modular dual-bag system in a front pack configuration according to an embodiment.

FIG. 2 is a front view of the bag shown in FIG. 1.

FIG. 3 is a side view of the bag shown in FIG. 1.

FIG. 4 is a rear view of one bag in a modular dual-bag system in a backpack configuration according to an embodiment.

FIG. 5 is a front view of the bag shown in FIG. 4.

FIG. 6 is a side view of the bag shown in FIG. 4.

FIG. 7 is a plan view of adjustable connecting straps according to an embodiment.

FIG. 8 shows the modular dual-bag system including two bags connected together according to an embodiment.

### DETAILED DESCRIPTION

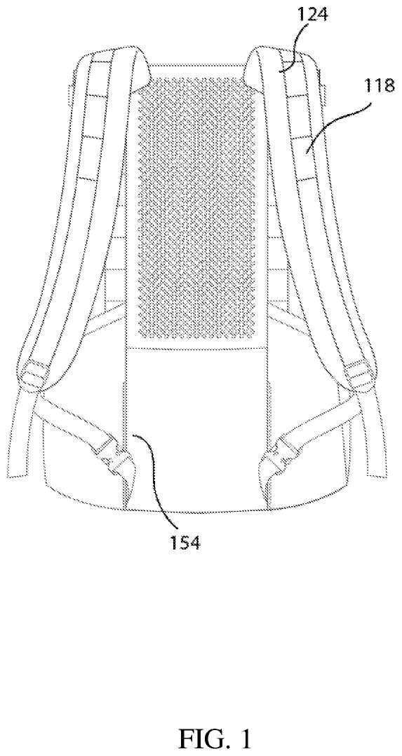

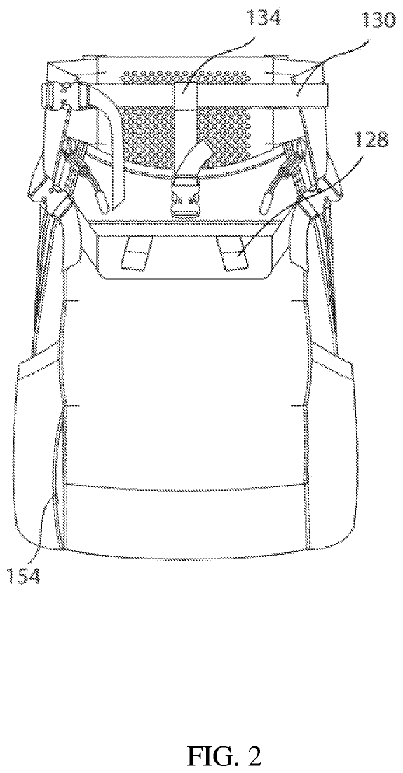

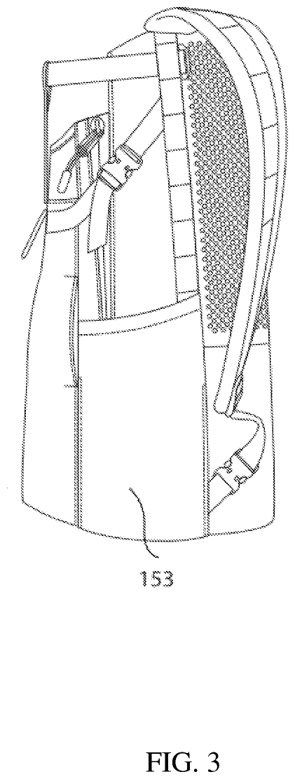

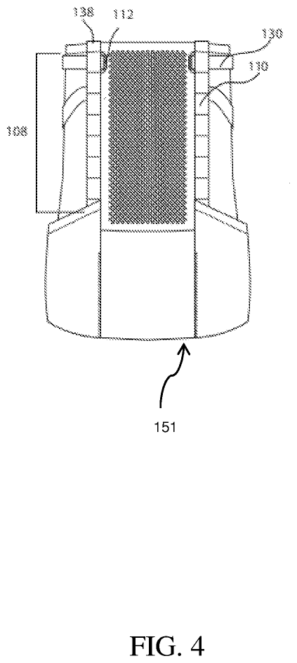

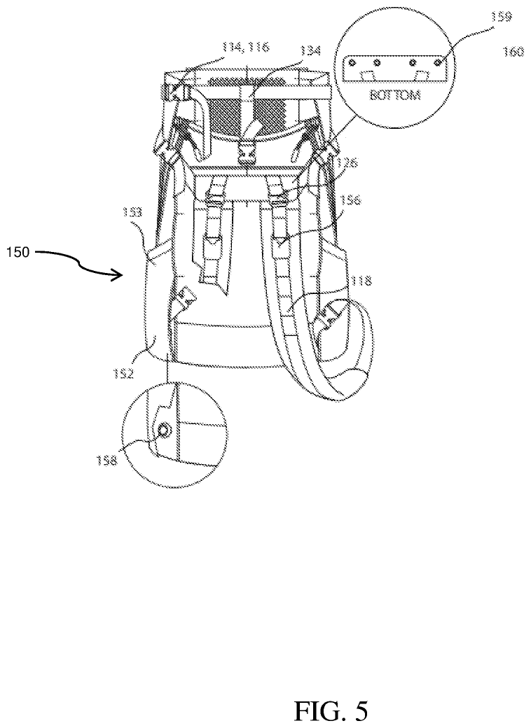

FIGS. 1-6 shows an embodiment of a modular dual-bag system including both a front bag 150 and a rear bag 151, with FIGS. 1-3 showing a bag in a front pack configuration and FIGS. 4-6 showing the bag in a backpack configuration. Both bags may have identical construction but different configurations to tailor the system to the user's preferences, as described below.

The bag portion 102 may be made available in different sizes for different sized pets. Side adjustment straps 106 may be provided near the top of each slit to further accommodate different sized pets. A ladder-style, or molle, harness system 108 may be provided on each side of the back side of the bag portion 102 to even further accommodate different sized pets. Each side of the strap system may include a number of molles 110. A T-shaped molle adjustment piece 112 may be placed in a desired molle for connection to the associated adjustment strap. The adjustment straps may include snap buckles and/or magnetic buckles 114. The snap buckles may include a male portion, e.g., a stud, (not shown) that may snaps into a socket 116 in the associated molle adjustment piece.

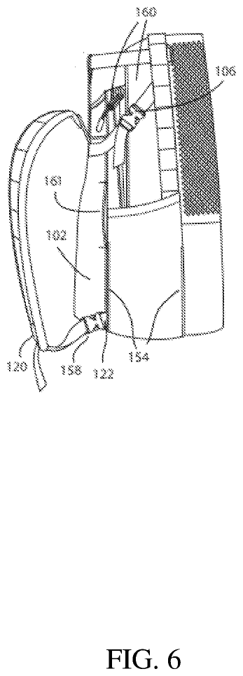

A pair of shoulder straps 118 may be provided for carrying the bag. The shoulder straps may include ladder lock 120 for adjusting the length of the straps to fit a user. A bottom portion 122 of each of a pair of shoulder straps 118 may be attached near the bottom of the bag portion 102, e.g., by stitching. In the backpack configuration, a top portion 124 of each shoulder strap 118 may be connected to the front side of the bag portion 102, as shown in FIG. 6. To attach a shoulder strap to the front side of the bag portion, a hook piece 126 may be inserted into a loop 128 stitched onto the front side of the bag portion.

A magnetic closure mechanism 152 may be positioned on the bag's lower rear side with a discreet magnet closure socket 152 concealed behind the double-layer water bottle pocket 153. This double-layer design of the water bottle pocket provides the pocket with an inner and outer layer, enabling the pocket to securely contain objects while allowing the bottom 122 of a shoulder strap 118 to pivot between front and back positions through slits 154 on the front and rear sides of the water bottle pocket 153. This magnetic closure feature facilitates the attachment of adjustable straps 155, which enables wearers to achieve a snug fit by drawing the two bags together.

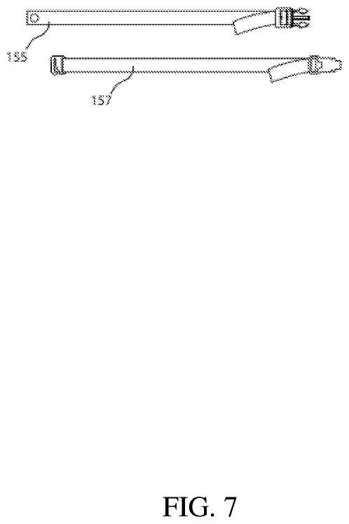

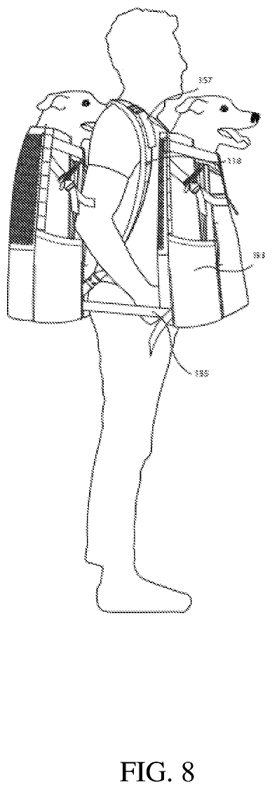

In the two bag configuration, the shoulder straps 118 on the front bag 150 may be removed. A detachable magnetic v-buckle on the shoulder strap 156 which may be seamlessly attached to a G-hook strap 157 (FIG. 7), which in turn is connected at one end to a loop 138 situated atop the back of the front bag 150 and at the other end to a selected molle on the shoulder strap 118 of the rear bag 151. This integration empowers users to effortlessly assemble the configuration of wearing two bags simultaneously, as shown in FIG. 8. As straps 155 are tightened, the magnets within the magnet closure 152 engage, establishing a robust connection that steadfastly prevents unintended detachment. This innovative arrangement ensures not only security but also seamless alignment and attachment of the bags. A noteworthy feature is the adjustability of the straps 155, catering to diverse body sizes and user preferences.

The bottom connection 122 of each shoulder strap 118 to the bags can swivel between front and back positions through slits 154 on the front and rear sides of the water bottle pocket 153. A side-release (SR) buckle 158 at the bottom 122 of the strap 118 allows for disconnection and reattachment, enabling adjustment between backpack and front-pack configurations. FIG. 1 displays the modular dual-bag system in a backpack configuration, demonstrating the swiveling shoulder straps 118 and the magnetic closure mechanism 152.

FIGS. 4-6 show the bag in the modular dual-bag system in front pack configuration. The shoulder straps 118 are attached to loops 128 on the back side of the bags, allowing users to wear the bags at the front. The molle harness system 108 on each side of the bags provides further customization. T-shaped molle adjustment pieces 112 fit into user selected molles, ensuring a secure fit for various pet sizes.

A collar strap 130 is connected near the top side of the back bag 151 to secure the pet, as depicted in FIG. 6. The collar strap 130 includes a buckle system, e.g., a magnetic short buckle or hook-and-loop connector for adjustability. A choke prevention strap 134 connects between the collar strap 130 and the front side of the bag 150 to prevent the pet from lifting its neck or climbing on the user's shoulders, thus preventing potential choking hazards. The choke prevention strap may also use a magnetic short buckle.

The figures and detailed descriptions illustrate the modular dual-bag system's innovative features, including the magnetic closure mechanism 152, swiveling shoulder straps 118, waist-level attachment straps 155, molle harness system 108, collar strap 130, and choke prevention strap 134.

The modular dual-bag system with magnetic closure and swiveling shoulder straps, as disclosed, introduces an innovative approach to versatile dog transportation. By seamlessly integrating magnetic closures, swiveling shoulder straps, and adjustable attachments, the system provides a user-friendly and adaptable solution for carrying two bags simultaneously in various configurations. This patent abstract and detailed description demonstrate the technical ingenuity and practical benefits of the modular dual-bag system, making it an ideal choice for dog owners and individuals seeking efficient and versatile bag arrangements.

The foregoing method descriptions and figures are provided as illustrative examples only. The order of operations in the aspects described herein may be performed in any order. Words such as “thereafter,” “then,” “next,” etc. are used to guide the reader through the description of the methods and systems described herein, and do not limit the order of the operations. Any reference to claim elements in the singular, for example, using the articles “a,” “an,” or “the” is not to be construed as limiting the element to the singular. Also, relative terms such as “top,” “bottom,” “upper,” “lower,” “above,” “below,” “front”, “back”, “rear” and the like as used herein describe the relative positions of elements or features, and are not limited to the orientations depicted in the drawings. Furthermore, the specific dimensions and other details set forth with regard to specific embodiments are for illustrative purposes only and are not intended to limit the scope of the claims.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the specific embodiments described herein but is to be accorded the widest scope consistent with the claims.

1. A personal pet carrier system, comprising:
a bag portion including a front side and a back side connected on a bottom of the bag portion and partially up at least one side to form an open slit on said side;
a side strap having a first end connected adjacent to a top portion of the open slit on the front side of the bag portion and a second end including a buckle;
a buckle receiving piece connected adjacent to a top portion of the open slit on the back side of the bag portion and adapted to connect with the buckle;
at least one shoulder strap connected to the bag portion; and
a magnetic closure mechanism positioned adjacent the back side at the bottom of the bag portion configured to accept a strap with a corresponding magnetic mechanism to enable secure attachment with another personal pet carrier and enable a user to wear said pet carriers simultaneously.

2. The personal pet carrier system of claim 1, further comprising:
a collar strap connected adjacent to a top side of the back side of the bag portion; and
a choke prevention strap connected between the collar strap and the front side of the bag portion.

3. The personal pet carrier system of claim 1, further comprising:
a connection loop or ring adjacent the top rear of the bag portion;
an upper connecting strap for connection to the connection loop at one end and to a shoulder strap of another bag at another end in a two-bag configuration; and
a lower adjustable connecting strap for connection to the magnetic closure mechanism to facilitate tightening and bringing the bags to a desired distance in a two-bag configuration.

4. The personal pet carrier system of claim 3, further comprising:
a pocket having a first slit on a front side and a second slit on a rear side, the pocket being adjacent the bottom of the bag portion, wherein the magnetic closure mechanism is concealed in the pocket;
a swiveling attachment connected to an and of the adjustable connecting strap, configured to enable the adjustable connecting strap to be extended from either the first slit or second slit to enable either a front bag configuration or a rear bag configuration.

5. The personal pet carrier of claim 1, wherein the buckle comprises a magnetic buckle.
